(19) United States
(12) Patent Application Publication
(10) Pub. No.: US 2012/0266657 A1
(43) Pub. Date: Oct. 25, 2012

(54) DEVICE AND METHOD FOR CONTROLLING AN EXHAUST GAS SENSOR

(75) Inventors: Stefan Barnikow, Muenchen (DE); Ekkehart-Peter Wagner, Bad Abbach (DE)

(73) Assignee: CONTINENTAL AUTOMATIVE GMBH, HANOVER (DE)

(21) Appl. No.: 13/503,495

(22) PCT Filed: Oct. 20, 2010
(86) PCT No.: PCT/EP2010/065760

§ 371 Date: Jun. 28, 2012

(30) Foreign Application Priority Data
Oct. 22, 2009 (DE) 102009050224.6

(51) Int. Cl. G01N 27/00

(52) U.S. Cl. 73/31.05

(57) ABSTRACT

A device for controlling an exhaust gas sensor that is alternatively configured as a limiting-current probe or as a two-cell probe. In each case, the probe has a reference cavity made of a ceramic material and a cell made of a material conducting oxygen ions. A controller has one input variable that is a measured sensor voltage dependent on an oxygen concentration in the sealed cell. The other input variable is a reference voltage. The output variable of the controller is a current which is to be applied to the cell and which allows the sensor voltage to be regulated to a predefined value. The device for controlling the limiting-current probe is designed to process the applied current in one of the input variables of the controller.

The invention relates to a device and a method for controlling an exhaust gas sensor which is embodied either as a limiting current probe or as a two cell probe, each of which comprises a reference cavity made of a ceramic material and a cell made of a material which conducts oxygen ions.

When internal combustion engines are operated, exhaust gas sensors whose signal is used to control the emissions of the internal combustion engines are used to ensure compliance with legally stipulated emission limiting values. Exhaust gas sensors which are frequently used are what are referred to as binary and linear lambda probes and NOx sensors. These types of exhaust gas sensors each comprise a heated solid electrolyte made of yttrium-stabilized zirconium dioxide ceramic (ZrC>2). In order to be able to measure the oxygen concentration or NOx concentration in the form of a flow of oxygen ions through the solid electrolyte in exhaust gas sensors which are composed of zirconium dioxide, there is provision for the ceramic to be heated. The target temperature is either adjusted to a predefined value or pilot-controlled as a function of the operating point.

The basic material, zirconium dioxide, has two significant properties:
1. If an oxygen concentration of lambda=1 is applied to one electrode of the exhaust gas sensor and an oxygen concentration of lambda=infinite (equivalent to ambient air) is applied to another electrode of the exhaust gas sensor, an electrical voltage of 450 mV occurs between the two electrodes. This voltage is referred to as a Nernst voltage, named after the physicist Walther Nernst.
2. If an electrical current is fed through the zirconium dioxide of the exhaust gas sensor, oxygen particles are transported through the zirconium dioxide.

A widespread design of linear exhaust gas sensors comprises an arrangement of two cells of the basic material zirconium dioxide which are connected to one another. In the one cell, referred to as the Nernst cell, the property mentioned above under 1. is utilized here. In the other, second cell, which is referred to as a pumping cell, the property mentioned above under 2. is utilized. In such a linear exhaust gas sensor, a reference cavity, which is connected to the stream of exhaust gas through a diffusion barrier and in which an oxygen concentration of lambda=1 is intended to occur, is located between the two cells. As long as the oxygen concentration has the value lambda=1, an electrical voltage of 450 mV can be measured between the electrodes of the Nernst cell. However, as soon as oxygen particles flow in or out through the diffusion barrier caused by a deviation from the ideal oxygen concentration lambda=1 in the exhaust gas, the oxygen concentration in the enclosed cell is influenced. As a result, the electrical voltage between the electrodes of the Nernst cell differs from the 450 mV to be achieved.

An electronic controller or control device which is connected to the exhaust gas sensor has the function of measuring the voltage value across the Nernst cell which deviates from the 450 mV and of initiating a suitable counter-reaction in order to obtain the voltage of 450 mV again. The counter-reaction consists in sending an electrical current through the pumping cell of the exhaust gas sensor. As a result, so many oxygen particles are transported into the reference cavity that the oxygen concentration is compensated again to lambda=1. The flow of current can occur in both directions here, since the oxygen concentration in the exhaust gas can also either be higher or lower than lambda=1.

In terms of control technology, the exhaust gas sensor therefore constitutes a control section which has to be kept at the working point by the connected control device. The exhaust gas sensor and control device therefore form a control loop in which the control device constitutes or comprises a controller.

Another, widespread design of linear exhaust gas sensors comprises, apart from the reference cavity, just one cell of the basic material of zirconium dioxide. These are referred to as limiting current probes. Typically a variable voltage is applied to the single cell. The flow of current through this cell depends essentially on the level of the applied voltage and on the oxygen concentration in the exhaust gas section which is separated by a diffusion barrier. The characteristic of the current is such here that the current remains relatively constant in a voltage range around 450 mV, while it changes to a high degree when there are considerable deviations from 450 mV. The level of the current in this “plateau region” is dependent on gas diffusion rates into the reference cavity, which in turn depend on the gas concentrations in the exhaust gas, and the level of said current can therefore be used as a measure of the oxygen concentration in the exhaust gas.

The different ways of controlling the two specified exhaust gas sensor types requires a specific control device in a particular case. Since the control devices are frequently monolithically integrated into specific, integrated circuits, providing the control device entails a high degree of organizational effort and financial expenditure.

The object of the present invention is therefore to specify a device and a method for controlling an exhaust gas sensor which permit optional operation of the one exhaust gas sensor or of the other exhaust gas sensor. In particular, the optional operation is to be made possible without additional hardware components, in order to achieve a high level of flexibility.

These objects are achieved by means of a device according to the features of patent claim 1, and by means of a method according to the features of patent claim 7. Advantageous refinements can be found in the respective dependent patent claims.

The invention provides a device for controlling an exhaust gas sensor which is embodied either as a limiting current probe or as a two cell probe, each of which comprises a reference cavity and a cell made of a material which conducts oxygen ions, for example zirconium oxide. In a known fashion, such a cell comprises two electrodes, wherein the one electrode is connected to the reference cavity and the other electrode to a volume which is filled with a lean gas mixture (for example air). The device comprises at least one controller, the one input variable of which is a measured sensor voltage which is dependent on an oxygen concentration in the reference cavity, and the other input variable of which is a reference voltage. The output variable of said controller is a current which is to be impressed into the cell of the sensor and by means of which the sensor voltage can be adjusted to a predefined value. According to the invention, the device for controlling the limiting current probe is designed to process the impressed current in one of the input variables of the controller. The invention provides a method for controlling an exhaust gas sensor which is embodied either as a limiting current probe or as a two cell probe, which each comprises a reference cavity made of a ceramic material and a cell made of a material which conducts oxygen ions. In the method, a sensor voltage, which is dependent on an oxygen concentration in the reference cavity, is fed to a controller as an input variable. A reference voltage is fed to the controller as another input variable. A current, which is an output variable of the controller, is impressed into the cell of the sensor, with the result that the sensor voltage is adjusted to a predefined value. In this context, the impressed current is processed in one of the input variables of the controller.

The method according to the invention and the device according to the invention make it possible to operate different types of exhaust gas sensors with a single control device, and this is based essentially on the concept of the two cell probe. The idea underlying the invention consists in operating both a limiting current probe and the two cell probe in a control loop. In a way which is analogous to the two cell probe, in the case of the current limiting probe the voltage across the cell is also to be measured and a current is to be impressed into this cell as a function of the measured voltage. In order to prevent falsifications of the measured voltage by the internal resistance of the limiting current probe, the impressed current is taken into account as an input variable of the control loop.

One advantage of this procedure is that it provides a high degree of flexibility when using exhaust gas sensors, in particular lambda probes. In contrast to the previous limitation to a specific type of lambda probes when the necessary control device is defined and implemented, the invention permits the control for the limiting current probe and the two cell probe to be as desired, because it is similar. Such a device is therefore capable of operating various types of exhaust gas sensors. In contrast to previously implemented, complex controllers of limiting current probes, in which a variable voltage is applied to the reference cavity and a resulting current is measured, the invention permits the control of linear probes of different designs to be standardized.

According to one expedient refinement, the input variable of the controller for controlling the two cell probe is a Nernst cell voltage. Accordingly, in the method according to the invention the Nernst cell voltage is processed as an input variable of the controller for controlling the two cell probe.

In contrast, the input variable of the controller for controlling the limiting current probe or the two cell probe is a computationally determined Nernst cell voltage. In a way which corresponds to this, the computationally determined Nernst cell voltage is processed as an input variable of the controller for controlling the limiting current probe or the two cell probe.

A further refinement provides that the device for controlling the limiting current probe is designed to correct the measured sensor voltage or the reference voltage by the internal resistance of the limiting current probe before the further processing, in order to determine the output variable. In a corresponding way, in the method according to the invention the measured sensor voltage or the reference voltage is corrected by the internal resistance of the limiting current probe before the further processing, in order to determine the output variable. As a result, falsifications of the measured voltage by the internal resistance of the limiting current probe can be avoided. The voltage drop at the probe caused by the internal resistance can be determined from the product of the internal resistance and a function of the control output variable, i.e. the current which is to be impressed into the enclosed cell. This may be, for example, the current value itself or else be a low pass filtering of the current value. This correction can be optionally taken into account in one of the two input variables. Since the current through the probe constitutes directly the “plateau current” in the characteristic of the exhaust gas sensor, said current can be processed directly as a measure of the lambda value in the exhaust gas section.

According to a further refinement, the device is designed to determine the current used as an output variable from the corrected sensor voltage. In a way which corresponds to this, in the method according to the invention the current which is to be used as an output variable is determined from the corrected sensor voltage.

In particular, the output variable of the control loop for controlling the limiting current probe is a measure of the lambda value. In the method according to the invention, the output variable of the control loop for controlling the limiting current probe is correspondingly processed as a measure of the lambda value.

The invention will be explained in more detail below with reference to an exemplary embodiment. In the drawing:

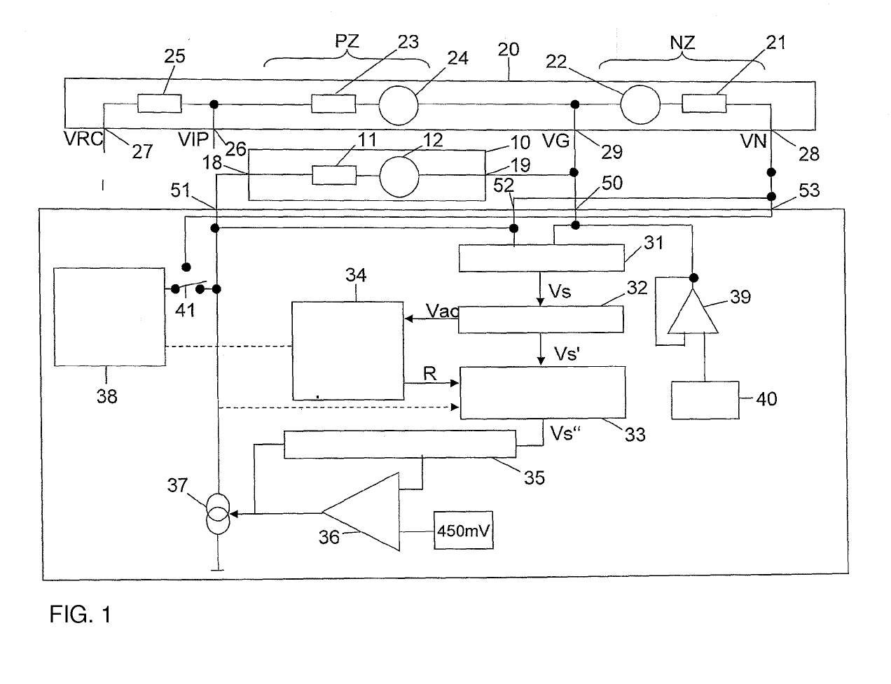

FIG. 1 is a schematic illustration of a device according to the invention, for controlling an exhaust gas sensor which is embodied either as a limiting current probe or as a two cell probe, and

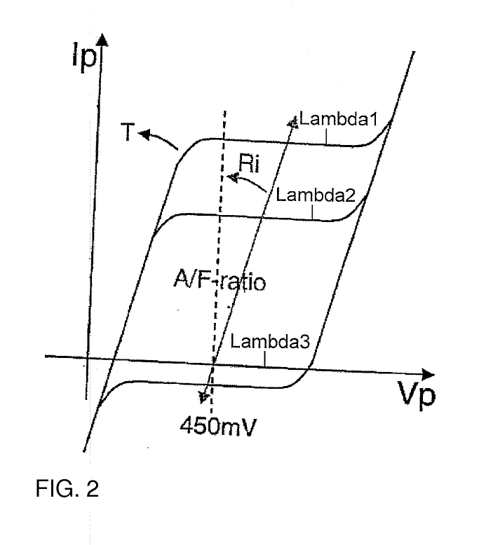

FIG. 2 is the current/voltage characteristic of a limiting current probe.

FIG. 1 shows a schematic illustration of a control device 30 which can be used for controlling either a limiting current probe 10 or a two cell probe 20. The limiting current probe 10 and the two cell probe 20 are each represented as an electrical equivalent circuit diagram.

The limiting current probe 10 (also referred to as single-cell probe) is, as is known to a person skilled in the art, represented by an internal resister 11 and a voltage source 12. The two elements are connected serially between terminals 18, 19 of the limiting current probe 10. The limiting current probe 10 is composed, as is also known to a person skilled in the art, of just one cell of the basic material zirconium dioxide, to which cell a variable voltage is usually applied, wherein the flow of current through the individual cell depends on the level of the applied voltage and on the oxygen concentration in the exhaust gas section which is separated by a diffusion barrier. The characteristic of the current is such here that the current remains relatively constant in a voltage range around 450 mV, while it changes to a high degree when there are deviations from 450 mV. The level of the current in this plateau region is dependent on gas diffusion rates into the reference cavity, which in turn depend on the gas concentrations in the exhaust gas, and the level of said current can therefore be used as a measure of the oxygen concentration in the exhaust gas.

This context is illustrated schematically in FIG. 2, which represents a group of curves for different lambda values (A/F ratio) in a current/voltage diagram. Here, the voltage Vp which drops across the limiting current probe is plotted on the abscissa. On the ordinate the current Ip which flows through the limiting current probe or is impressed therethrough is plotted. As is readily apparent from this illustration, the current/voltage characteristic curves run in a ramp shape outside the plateau region, wherein the gradient is dependent on the internal resistance Ri and therefore indirectly on the temperature of the enclosed cell of the limiting current probe 10. The level of the plateaus of the different groups of curves is dependent on the oxygen concentration in the exhaust gas section, wherein FIG. 2 shows by way of example three curves, which are denoted in accordance with their different lambda values by Lambda1, Lambda2 and Lambda3. Depending on the internal resistance of the sensor element and the lambda value of the exhaust gas flowing around the probe, a voltage value of 450 mV, which is to be achieved, is present in the center of the plateau region (cf. Lambda3) or at the edge (cf. Lambda1). However, it is desirable, irrespective of the temperature and lambda value, for the voltage value to be achieved to be in the center of the plateau region.

The two cell probe 20 is composed of an arrangement of two cells of the basic material zirconium dioxide, referred to as the Nernst cell NZ and the pumping cell PZ, which are connected to one another. The Nernst cell NZ is formed by an internal resistor 21 and a voltage source 22, which are connected serially between terminals 28, 29 of the two cell probe. In a corresponding way, the pumping cell PZ is also formed by an internal resistor 23 and a voltage source 24. These two elements are also connected serially to one another, wherein the series circuit is arranged between the terminal 29 and a further terminal 26 of the two cell probe 20. A resistor 25, which forms a calibrating resistor, is arranged between the terminal 26 and a further terminal 27.

A reference cavity which is connected to the stream of exhaust gas through a diffusion barrier is located between the Nernst cell NZ and the pumping cell PZ. In said reference cavity there is to be an oxygen concentration of lambda=1, wherein the fuel mixture is then burnt to an optimum degree. As long as lambda=1, an electrical voltage of 450 mV is measured between the electrodes of the Nernst cell, as is known. However, as soon as oxygen particles flow in or out through the diffusion barrier in the exhaust gas, caused by a deviation from the ideal oxygen concentration lambda=1, the oxygen concentration in this enclosed cell is influenced. As a result, the electrical voltage between the electrodes (connected to the terminals 28, 29) of the Nernst cell also differs from 450 mV.

When the two cell probe 20 is controlled by the control device 30, the objective is then to measure a voltage deviation across the Nernst cell from the ideal 450 mV and to initiate a suitable counter-reaction. This counter-reaction consists in impressing into the pumping cell PZ an electrical current Ip, as a result of which so many oxygen particles are sent into the reference cavity that the oxygen concentration is compensated again to lambda=1. The flow of current can occur in both directions here since the oxygen concentration in the exhaust gas may be either higher or lower than lambda=1. The two cell sensor 20 therefore constitutes a control section which has to be kept at the working point by the connected control device (which has the function of a controller). In the case of the two cell probe 20, the controller input variable is the Nernst voltage at a level of 450 mV, while the controller output variable is the pumping current Ip through the pumping cell PZ. The Nernst voltage is to be kept here at a value of 450 mV through a dynamically correct increase or reduction in the pumping current. The control device 30 according to the invention is designed also to operate the limiting current probe in such a control loop. In such a way which is analogous to the two cell probe 20, the voltage across the limiting current probe 10, i.e. the terminals 18, 19, is measured and a current is impressed into the limiting current cell as a function of the measured voltage. In order to avoid falsifications of the measured voltage by the internal resistance of the single-cell probe, the measured voltage is corrected by the voltage drop across the internal resistance before the further processing:

Vs′=Vs−(Ri*f(Ip))

The controller target variable remains a fixed variable in this case.

Alternatively, the measured voltage across the limiting current probe can also be used in an unchanged fashion as a controller input variable. However, in this case an “artificially calculated” Nernst voltage Vs′ must then be used, said Nernst voltage Vs′ being acquired from the measurement of the entire cell voltage according to the following calculation rule:

Vs′=Vs+(Ri*f(Ip)) (1)

Here, the current Ip which is to be impressed into the limiting current sensor is the controller output variable. Since this current constitutes directly the plateau current in the characteristic of the limiting current sensor, it constitutes a measure of the lambda value in the exhaust gas.

In contrast to the previously customary control of the single-cell probe using a variable voltage and measurement of the current, the advantage of the procedure is that the control principle is similar to the control concept of the two cell sensor. All that is necessary is to correct the target voltage of the controller by the product of a function of the probe current and of the impedance of the limiting current sensor in order to be able to measure a precise current value and therefore lambda value.

FIG. 1 shows in a schematic illustration the components which are necessary in the control device 30 in order also to operate a limiting current probe in a control loop. The control device 30 can be embodied as an integrated chip or an ASIC (Application Specific Integrated Circuit).

The inputs of an input amplifier 31, which is preferably embodied as an analog/digital converter, are connected to terminals 51, 52 and 50. The terminals 51, 52 may, in contrast to the graphic illustration, also be formed by a common terminal here. The terminals 18, 19 of the limiting current probe 10 or the terminals 28, 29 of the two cell probe 20 are coupled to the terminals 50 and 51, 52. An alternating current source for measuring the impedance is denoted by 38. Said alternating current source can apply an alternating current signal via a terminal 53 using a changeover switch 41 either to the limiting current probe 10 or to the two cell probe 20. The terminal 53 is connected to the terminal 28 of the two cell probe 20 or else via the terminal 51 to the terminal 18 of the limiting current probe 10. The terminal of the input amplifier 31, which is coupled to the terminal 50, is also connected to a fed-back comparator 39, the other input of which is connected to a virtual ground 40. The virtual ground makes available a reference potential for the control device 30, which potential is between 0 and 5 V. A voltage Vs is present at the output of the input amplifier 31, which voltage Vs corresponds to the cell voltage either of the limiting current probe 10 or of the Nernst cell NZ of the two cell probe 20.

Vs can additionally be a mixed signal which is provided with alternating voltage components (other embodiments are also conceivable) due to a continuously periodically carried out impedance measurement. The alternating voltage components are caused, for example, by impedance measurement of the two cell probe 20 or of the single-cell probe 10, by means of which a temperature measurement is carried out. Therefore, a circuit arrangement 32 for dividing signals from Vs into a direct voltage component and an alternating voltage component may also be connected downstream of the input amplifier 31. A direct voltage component Vs′ is fed to a compensation arrangement 33. An alternating voltage component Vac is fed to a device 34 for measuring impedance, which device 34 makes available an internal resistance value R to the compensation arrangement 33.

The compensation arrangement 33 is designed to determine an artificially calculated Nernst voltage Vs″ from the input variables, which Nernst voltage Vs″ corrects the measured voltage by the voltage drop across the internal resistor before the further processing. This is done according to equation (1). Vs″ is fed to a controller 35, for example a PID controller. The latter is coupled in a known fashion to a comparator 36, at whose reference input the voltage setpoint value (for example at a level of 450 mV) is present as a reference variable. On the output side, the comparator 36 and the controller 35 are connected to a controllable current source 37 (or a digital/analog converter on a current basis) which, depending on the exhaust gas sensor 10 or 20 connected, impresses a current into the respective connected cell in order to adapt Vs″ to the voltage setpoint value.

1-14. (canceled)

15. A device for controlling an exhaust gas sensor that is embodied either as a limiting current probe or as a two cell probe, each of which having a reference cavity of a ceramic material and a cell of a material that conducts oxygen ions, the device comprising:
at least one controller having an input for receiving an input variable being a measured sensor voltage that is dependent on an oxygen concentration in the reference cavity, an input for receiving an input variable being a reference voltage, and an output for outputting an output variable being a current to be impressed into the cell of the exhaust gas sensor and to adjust a sensor voltage to a predefined value; and
wherein the device for controlling the limiting current probe is configured to process the current being impressed in one of the input variables of said controller.

16. The device according to claim 15, wherein the input variable of the controller for controlling the two cell probe is a measured Nernst cell voltage.

17. The device according to claim 15, wherein the one input variable of the controller for controlling the limiting current probe or the two cell probe is a computationally determined Nernst cell voltage.

18. The device according to claim 15, wherein the device for controlling the limiting current probe is configured to correct the measured sensor voltage or the reference voltage by an internal resistance of the limiting current probe before further processing, in order to determine the output variable.

19. The device according to claim 15, wherein the device is configured to determine the current used as an output variable from the corrected sensor voltage.

20. The device according to claim 15, wherein the output variable of the controller for controlling the limiting current probe is a measure of a lambda value.

21. A method of controlling an exhaust gas sensor that is embodied either as a limiting current probe or as a two cell probe, wherein each has a reference cavity made of a ceramic material and a cell made of a material that conducts oxygen ions, the method which comprises:
feeding a sensor voltage, which is dependent on an oxygen concentration in the reference cavity, to a controller as an input variable;
feeding a reference voltage to the controller as another input variable;
impressing a current that is an output variable of the controller into the cell, to thereby adjust the sensor voltage to a predefined value; and
processing the impressed current in one of the input variables of the controller.

22. The method according to claim 21, which comprises processing a measured Nernst cell voltage as the input variable of the controller for controlling the two cell probe.

23. The method according to claim 21, which comprises processing a computationally determined Nernst cell voltage as an input variable of the controller for controlling the limiting current probe or the two cell probe.

24. The method according to claim 21, which comprises correcting the reference voltage that is fed to the controller by an internal resistance of the limiting current probe before further processing, in order to determine the output variable.

25. The method according to claim 24, which comprises determining the current to be used as an output variable from a deviation of the measured sensor voltage from the corrected reference voltage.

26. The method according to claim 21, which comprises correcting the measured sensor voltage by an internal resistance of the limiting current probe before further processing, in order to determine the output variable.

27. The method according to claim 26, which comprises determining the current to be used as an output variable from a deviation of the corrected sensor voltage from the reference voltage.

28. The method according to claim 21, which comprises processing the output variable of the controller for controlling the limiting current probe as a measure of a lambda value.
